(19) United States
(12) Patent Application Publication
(10) Pub. No.: US 2025/0267476 A1
(43) Pub. Date: Aug. 21, 2025

(54) DYNAMIC RECONFIGURATION FOR 5G TELECOMMUNICATIONS NETWORKS

(71) Applicant: DISH Wireless L.L.C., Englewood, CO (US)

(72) Inventors: Karupaiah Rajendran, Sachse, TX (US); Norberto Amaya Gonzales, San Diego, CA (US)

(21) Appl. No.: 18/442,710

(22) Filed: Feb. 15, 2024

(51) Int. Cl. H04W 24/02; H04W 24/08; H04W 28/02; H04W 76/20

(52) U.S. Cl. CPC H04W 24/02; H04W 24/08; H04W 28/0289; H04W 76/20

(57) ABSTRACT

Systems and methods of dynamically reconfiguring radio access network (RAN) components of a telecommunications network. One system may include a processing system. The processing system may be configured to monitor network traffic within the telecommunications network including a plurality of RAN components. The processing system may be configured to detect, based on the network traffic, a network condition at a first RAN component of the plurality of RAN components. The processing system may be configured to determine a reconfiguration operation based on the network condition. The processing system may be configured to dynamically reconfigure at least one of the plurality of RAN components of the telecommunications network by performing the reconfiguration operation.

### BACKGROUND

This disclosure relates to wireless data networks, such as fifth generation (5G) wireless networks. Wireless networks that transport digital data and telephone calls are becoming increasingly sophisticated. Currently, 5G broadband cellular networks are being deployed around the world. These 5G networks use emerging technologies to support data and voice communications with millions, if not billions, of mobile phones, computers, and other devices. 5G technologies are capable of supplying much greater bandwidths than previously-available technologies.

The discussion above is merely provided for general background information and is not intended to be used as an aid in determining the scope of the claimed subject matter.

### SUMMARY

Various aspects of the present disclosure relate to systems and methods in a virtualized telecommunications network to dynamically reconfigure network components in an automated manner.

According to one aspect of the present disclosure, a method of dynamically reconfiguring radio access network (RAN) components of a telecommunications network is provided. The method may include monitoring, with a processing system including one or more electronic processors, network traffic at a first distributed unit (DU) included in the telecommunications network. The method may include detecting, with the processing system, based on the network traffic, an occurrence of a network condition at the first DU. The method may include transmitting, with the processing system, a first one or more electronic signals forming a first electronic message to a centralized unit (CU) of the telecommunications network indicating the occurrence of the network condition. The method may include receiving, with the processing system, a second one or more electronic signals forming a second electronic message from the CU, where the second electronic message is responsive to the network condition. The method may include controlling, with the processing system, the first DU to perform a reconfiguration operation based on the second electronic message.

According to another aspect of the present disclosure, a system of dynamically reconfiguring radio access network (RAN) components of a telecommunications network is provided. The system may include a processing system comprising one or more electronic processors. The processing system may be configured to monitor network traffic within the telecommunications network including a plurality of RAN components. The processing system may be configured to detect, based on the network traffic, a network condition at a first RAN component of the plurality of RAN components. The processing system may be configured to determine a reconfiguration operation based on the network condition. The processing system may be configured to dynamically reconfigure at least one of the plurality of RAN components of the telecommunications network by performing the reconfiguration operation.

According to another aspect of the present disclosure, a non-transitory computer-readable medium is provided. The non-transitory computer-readable medium stores instructions that, when executed by at least one processor of a computer in a telecommunications network, cause the computer to perform operations comprising: receiving, at a first distributed unit (DU) of the telecommunications network, network traffic from a user equipment (UE) coupled to the telecommunications network; controlling handling of the network traffic with the first DU, executing a set of DU network functions, and a centralized unit (CU), executing a set of CU network functions, of the telecommunications network; receiving, at the first DU, subsequent network traffic; detecting a network condition at the first DU, wherein the network condition is a result of receiving the subsequent network traffic at the first DU; responsive to detecting the network condition, dynamically reconfiguring the first DU of the telecommunications network; and controlling handling of the subsequent network traffic using the dynamically reconfigured first DU of the telecommunications network.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 illustrates an example of a CU cloud configuration for a telecommunication network in accordance with various aspects of the present disclosure.

FIG. 4 schematically illustrates an example DU server in accordance with various aspects of the present disclosure.

FIG. 5 schematically illustrates an example CU server in accordance with various aspects of the present disclosure.

FIG. 6 is a flowchart of an example method for dynamically reconfiguring a telecommunications network in accordance with various aspects of the present disclosure.

FIG. 7 illustrates an example of re-routing network traffic as a reconfiguration operation in accordance with various aspects of the present disclosure.

FIG. 8 illustrates an example telecommunications network that has been dynamically reconfigured in accordance with some configurations.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like). As another example, the wireless communication networks described herein may comply with other industry standards, such as, e.g., the Distributed Radio Access Network (Distributed RAN or D-RAN) or the like.

D-RAN enables the distribution of radio access functions and the separation of control and user plane functions, which allows for the deployment of RAN functions in various locations, such as, e.g., remote radio heads (RRHs) and baseband units (BBUs). The BBUs may process the control plane functions and the user plane functions and the RRHs may handle radio frequency (RF) processing. Accordingly, D-RAN allows for the deployment of virtualized RAN functions such that RAN functions can be executed as software via a cloud infrastructure.

The O-RAN model follows a virtualized model for a 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Such computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as, e.g., Amazon Web Services (AWS), Azure, Google Cloud, or any private or public cloud(s).

The technology disclosed herein provides methods and systems for dynamically reconfiguring a telecommunications network (or one or more RAN components included therein). As described herein, the telecommunications network may be dynamically reconfigured responsive to a network condition (or an occurrence thereof). A network condition may include congestion, a lack of network traffic, failure, etc. In some configurations, the technology disclosed herein may detect the network condition by monitoring network traffic. In some configurations, the technology disclosed herein may determine key performance indicators (KPIs) (either at a network level or a component level). In some instances, the KPIs may be utilized by the technology disclosed herein to detect a network condition.

The technology disclosed herein may further facilitate and execute a reconfiguration operation to dynamically reconfigure the telecommunications network (or RAN component(s) included therein). In some examples, the technology disclosed herein may dynamically reconfigure a DU to execute CU functionality locally at the DU. In other examples, the technology disclosed herein may dynamically reconfigure a CU to execute DU functionality at the CU, such that, e.g., the CU handles a portion of network traffic for a DU. In still other examples, the technology disclosed herein may dynamically reconfigure a DU to re-route at least a portion of the network traffic at the DU to another component, such as, e.g., a different DU, a CU, etc. In still other examples, the technology disclosed herein may dynamically reconfigure a DU to execute CU functionality on behalf of another DU (e.g., a first DU may act as a CU to a second DU).

As used herein, network traffic may refer to one or more electronic signals or communication transmitted over a telecommunications network, including, communication between components of the telecommunications network.

Accordingly, the technology disclosed herein provides smart systems and methods to update and reconfigure CU(s) configurations, DU(s) configurations, or a combination thereof to dynamically meet user capacity, site capacity, and user experience improvement demands, while also operating within designed network specifications. The technology disclosed herein may generate alarms as feedback for additional support to resolve deficiencies in meeting user capacity, site capacity, and user experience improvement demands. The technology disclosed herein may identify DU additional capacity dynamically based on, e.g., performance KPIs and set, configure, and identify parameter values related to capacity. In some instances, the technology disclosed herein may proactively plan for reconfiguration of network outages impacting reconfiguration parameters as flagged appropriately during the design and implementation phase of software development and improved algorithm for dynamic capacity and user experience improvement.

The technology disclosed herein may provide technical advantages and solutions over other or prior approaches. For instance, the technology disclosed herein may reduce usage of cloud resources by efficiently re-routing network traffic, which may result in deactivating one or more components. Reducing a total number of components actively running may result in a more efficient system, which, ultimately, results in energy savings (e.g., utilizing a device when network demand necessitates it). For example, during low traffic periods (e.g., at night), the technology disclosed herein may reconfigure the telecommunications network such that a total number of CUs running is reduced (e.g., by pushing network traffic to another network component having available capacity). Accordingly, the technology disclosed herein may reduce latency while improving network performance, which may also result in better user capacity handling and cost savings.

Additionally, the technology disclosed herein may further reduce signaling between a DU and a CU, which results in a reduced latency, improved performance, and energy improvements. The technology disclosed herein may improve outage handling. For instance, when a CU is down, the role or functionality of the CU that is down may be shifted to another network component, such as, e.g., a DU. Shifting functionality of a down component to an available component provides for efficient outage handling, such that the network may continue to run even though a component may be down.

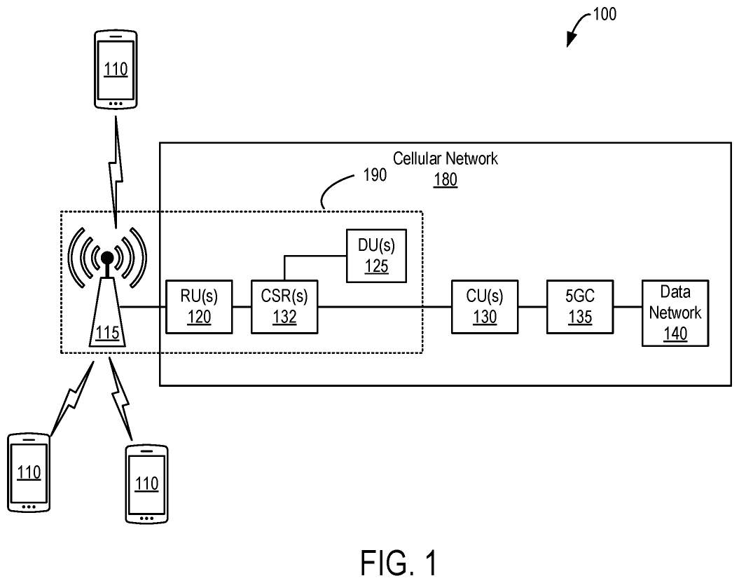

FIG. 1 illustrates an example of a telecommunications network 100 in accordance with various aspects of the present disclosure. In the telecommunications system 100 of FIG. 1, one or more user equipment (UE) 110 may be connected to a wireless access point 115, which in turn may be connected to a set of virtualized radio access network (RAN) components, including, e.g., one or more radio units (RUs) 120, distributed units (DUs) 125, centralized units (CUs) 130, or a combination thereof. The virtualized RAN components may provide a connection to a 5G core network (5GC) 140, which in turn may provide a connection to a data network 145. The data network 145 may be the Internet, an enterprise data network, combinations thereof, or the like. The wireless access point 115 and the virtualized RAN components may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network, including, e.g., a telecommunication network capable of being virtualized.

As used herein, the term “UE” may be one of various types of end-user devices, such as a cellular phone, a smartphone, a cellular modem, a cellular-enabled computerized device, a sensor device, robotic equipment, a vehicle, an Internet of Things (IoT) device, a gaming device, an access point (AP), or any computerized device capable of communicating via a cellular network (e.g., a cellular network 180). More generally, the UEs 110 can represent any type of device that has an incorporated 5G interface, such as a 5G modem. Examples can include a sensor device, an IoT device, a manufacturing robot, an unmanned aerial (or land-based) vehicle, a network-connected vehicle, etc. Depending on the location of individual UEs 110, the UEs 110 may use radio frequency (RF) to communicate with various base stations of a telecommunications network (e.g., the wireless access point 115 of the telecommunications network 100 of FIG. 1). While FIG. 1 illustrates three UEs 110 connected to the wireless access point 115, in practical implementations any number of UEs 110 may be connected to the wireless access point 115 at any given time.

The wireless access point 115 may represent the physical infrastructure (e.g., a 5G tower or base station) to which the UE(s) 110 connect. The wireless access point 115 may be any structure to which one or more antennas are mounted. The wireless access point 115 may be a dedicated cellular tower, a building, a water tower, or any other man-made or natural structure to which one or more antennas can reasonably be mounted to provide cellular coverage to a geographic area.

The wireless access point 115 may include the RU(s) 120 configured to convert radio signals sent to and received from the antenna(s) into a digital signal. The wireless access point 115 is connected to the virtualized RAN components via a fronthaul link over which the digital signals may be communicated. The virtualized RAN components may include the DU(s) 125 connected to the CU(s) 130 via a mid haul link. The CU(s) 130 may be connected to the 5GC 135 via a backhaul link. While FIG. 1 illustrates a single wireless access point 115, in practical implementations the telecommunications network 100 may include any number of wireless access points 115.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites.

As illustrated in FIG. 1, the wireless access point 115 may be associated with (or otherwise include) the RU(s) 120, one or more cell site routers (CSRs) 132 (also referred to as cell site gateways), and the DU(s) 125. In some configurations, the RU(s) 120, the DU(s) 125, or a combination thereof may be a virtualized RAN component. In some configurations, the RU 120, the CSR 132, the DU 125, or a combination thereof may be included as part of the wireless access point 115 (e.g., as wireless access point equipment 190). For instance, in some configurations, the RU 120, the CSR 132, and the DU 125 may be wireless access point equipment 190 for the wireless access point 115.

The RU 120 may process digital radio signals and transmits, receives, and converts the signals for a RAN base station (e.g., the wireless access point 115). For instance, when the RU 120 receives signal information from the antennas of the wireless access point 115, the RU 120 may facilitate signal processing such that the signal information received from the antennas may be transmitted or forwarded to the 5GC 135. In some configurations, as part of the signal processing process, the RU 120 may communicate the signal information to a baseband unit (BBU), where the BBU may process the signal information prior to the signal information being forwarded to the 5GC 135.

The DU 125 may be configured to handle network traffic (e.g., the signal information received via the antennas of the wireless access point 115 from the UE(s) 110). In some configurations, the DU 125 may be a software module that may be controlled by the CU 130. The DU 125 may control the radio link control/the medium access control (RLC/MAC) block, and one or more parts of the physical (PHY) layer. The RLC/MAC block is the basic transport unit on the air interface that is used between mobile and network.

The CU 130 may manage and/or control the DU 125. For instance, in some configurations, the CU 130 is a software module that executes radio resource control (RRC) to facilitate information broadcasting, establishing and releasing connections between the UE(s) 110 and the RAN, controlling quality of service, etc. The CU 130 may also implement packet data convergence protocol (PDCP) for compressing and decompressing IP data stream headers, transferring user data, etc. Alternatively, or in addition, in some configurations, the CU 130 may implement a service data adaptation protocol (SDAP) for mapping between a quality-of-service flow from the 5GC 135 and one or more data radio bearers (DRBs).

The CSR(s) 132 may function as a gateway between a cell site (e.g., the wireless access point 115) and a core network (e.g., the 5GC 135). In some configurations, the CSR(s) 132 may aggregate mobile data traffic from a cellular access network (e.g., mobile data traffic received at the wireless access point 115 from the UE(s) 110) and transmits (or otherwise provides) the aggregated mobile data traffic to a service provider's core network (e.g., the 5GC 135). For example, as illustrated in FIG. 1, in some configurations, the RU 120 and the DU 125 may communicate via the CSR 132, and the DU 125 and the CU 130 may communicate via the CSR 132.

FIG. 1 represents one example of a component level view. In an O-RAN, where components can be implemented as software in the cloud, except for components that need to receive and transmit RF, the functionality of the various components may be shifted among different servers to accommodate where the functionality of such components is needed.

The wireless access point 115 may include one or more antennas (not illustrated) that enable wireless communication between the RU(s) 120 and the UE(s) 110. The RU(s) 120 can represent an edge of the cellular network 180 where data is transitioned to wireless communication. The radio access technology (RAT) used by the RU 120 may be 5G New Radio (NR), or some other RAT. In some configurations, the remainder of the cellular network 180 may be based on an exclusive 5G architecture, a hybrid 4G/5G architecture, a 4G architecture, or some other cellular network architecture.

The RU(s) 120 may communicate with the DU(s) 125. As an example, at a possible cell site, three RUs 120 may be present (e.g., an alpha RU, a beta RU, and a gamma RU), where each RU 120 may be connected with the same DU 125. Different RUs 120 may be present for different portions of the spectrum. For instance, a first RU may operate on the spectrum in the citizens broadcast radio service (CBRS) band while a second RU may operate on a separate portion of spectrum, such as, for example, band 71.

In the illustrated example, the DU(s) 125 may communicate with the CU(s) 130. Collectively, the RU(s) 120, the DU(s) 125, and the CU(s) 130 create a gNodeB, which serves as the RAN of the cellular network 180. The CU(s) 130 can communicate with the 5GC 135. The specific architecture of cellular network 180 can vary by embodiment. Edge cloud server systems outside of the cellular network 180 may communicate, either directly, via the Internet, or via some other network, with components of the cellular network 180. For example, the DU(s) 125 may be able to communicate with an edge cloud server system without routing data through the CU(s) 130 or the 5GC 135. Other DUs 125 may or may not have this capability.

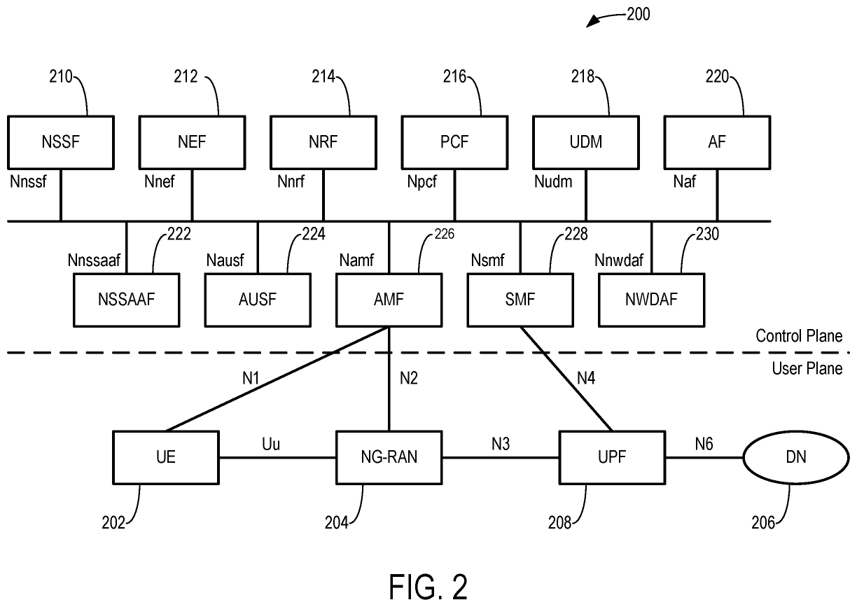

The 5GC 135 can be physically distributed across data centers or located at a central national data center (NDC). The 5GC 135 can perform various core functions (or network functions) of the cellular network 180. In the topology of a 5G NR cellular network (e.g., the cellular network 180), 5G core functions of the 5GC 135 can logically reside as part of an NDC. An NDC can be understood as having its functionality existing in a cloud computing region across multiple availability zones. This arrangement allows for load-balancing, redundancy, and fail-over. In local zones, multiple regional data centers can be logically present. Each of the regional data centers may execute 5G core functions for a different geographic region or group of RAN components. An example of 5G core components that can be executed within an NDC are described in more detail with regard to FIG. 2.

FIG. 2 illustrates an example service-based architecture (SBA) 200 for a telecommunications network (e.g., the telecommunications network 100 of FIG. 1) in accordance with various aspects of the present disclosure. The SBA 200 is divided between a control plane (CP) and a user plane (UP). The CP includes a plurality of CP network functions (NFs). The UP includes a UE 202 (e.g., one of the UEs 110 of FIG. 1) connected to an NG-RAN 204, and UP NFs. Using the SBA 200, the UE 202 accesses a data network 206 (e.g., the data network 140 of FIG. 1). For ease of illustration, FIG. 2 only shows a single UE 202 being connected to the NG-RAN 204; however, in practical implementations any number of UEs 202 may be present, limited only by the capacity of the network. Any of the NFs illustrated in FIG. 2 and/or described herein may be implemented as a software unit residing on a server (i.e., in the cloud).

The UP NFs may include a User Plane Function (UPF) 208. The UPF 208 is a NF that routes and forwards UP data packets between the base station (cell site; for example, the NG-RAN 204) and the data network 206 (e.g., the Internet). The UPF 208 may be similar to the service and packet gateway functions in a 4G network, but the UPF 208 is cloud-native and can be deployed anywhere to meet service requirements. The UPF 208 can also manage, prioritize, and duplicate data packets as those data packets traverse the network, thus offering redundancy and quality-of-service (QoS) assurance.

The CP NFs may include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 may be a CP function that provides network slices to the AMF 226. A network slice is an independent, end-to-end logical network that runs on shared physical network infrastructure. The network slice involves the allocation of network resources across all network infrastructure to meet specific service requirements, from the network core to the RAN. Specific requirements may include QoS assurance, security policies, data isolation, dynamic policy management, etc.

The NEF 212 may be a CP function that provides information regarding the NFs that are available to use (by the enterprise customer). The NEF 212 may be similar to the 4G Service Capabilities Exposure Function (SCEF), but the NEF 212 is cloud-native and exposes event information, network monitoring, network control, provisioning capabilities, and policy/charging capabilities externally. This allows the enterprise customer to monitor and affect QoS and charging for devices.

The NRF 214 may be a CP function that allows 5G NFs to be registered, discovered, and subsequently made available to customers. This is a unique capability in the SA 5G network that allows customers to subscribe to the necessary microservices or to have dedicated NFs for their services.

The PCF 216 may be a CP function that provides policies for mobility and session management. The PCF 216 may be similar to the Policy and Charging Rules Function (PCRF) in a 4G network, but the PCF 216 is cloud-native and offers additional capabilities in the 5G network, including event-based policy triggers, resource reservation requests, and access network discovery and selection. The PCF 216 may directly influence QoS and subscriber spending limits, and, as a result, may play a role in the enhanced policy management and control capabilities of the 5G network.

The UDM 218 may be a CP function that manages and stores subscriber and device information, default QoS and prioritization, authorized data channels, maximum bit rates, service continuity provisions, and the like. The UDM 218 may be similar to the Home Subscriber Server (HSS) function in a 5G network, but the UDM 218 is cloud-native and designed for 5G services.

The AF 220 may be a CP function that interacts with the 3GPP Core Network in order to provide services, for example, to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 may be a CP function that supports authentication and authorization of slicing with an AAA server (Authentication, Authorization, and Accounting). The NSSAAF 222 may be a unique capability of the SA 5G network that allows customers to access a predefined network slice or a newly requested network slice in real-time (or near real-time) and using their own existing authentication infrastructure.

The AUSF 224 may be a CP function that supports authentication for 3GPP access and untrusted non-3GPP access, and authentication of a UE for a disaster roaming service. The AUSF 224 can act as an authentication server.

The AMF 226 may be a CP function that manages registration, authorization, connection, reachability, and mobility. The AMF 226 may be similar to the Mobility Management Entity (MME) function in a 4G network, but the AMF 226 is cloud-native and supports many additional capabilities unique to 5G. For example, the AMF 226 may also support dynamic updating of network interfaces and cellular sites, greater privacy via the use of a 5G temporary device identity, enhanced security across the user and control planes, and storing of network slice information. The AMF 226 can also select an appropriate PCF for a device or use case.

The SMF 228 may be a CP function that oversees packet data session management, IP address allocation, data tunneling from a cell site base station to the UP function, and downlink notification management. The SMF 228 may perform the tasks of the serving and packet gateways (S-GW & P-GW) in a 4G network, but also allows for CP and UP separation in 5G.

The NWDAF 230 may be a CP function that collects data from pertinent network infrastructure relevant to a customer's services, including UE (device), NFs, network operations and administration, cloud, and edge that can be used for data analytics and insights. The NWDAF 230 may be a unique SA 5G NF that exposes full visibility to network performance and operations as they relate to a customer's key performance indicators (KPIs).

The SBA 200 may further include a plurality of service-based interfaces to provide access to or communication with the various NFs. As illustrated, such service-based interfaces may include an Nnssf interface for the NSSF 210, an Nnef interface for the NEF 212, an Nnrf interface for the NRF 214, an Npcf interface for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

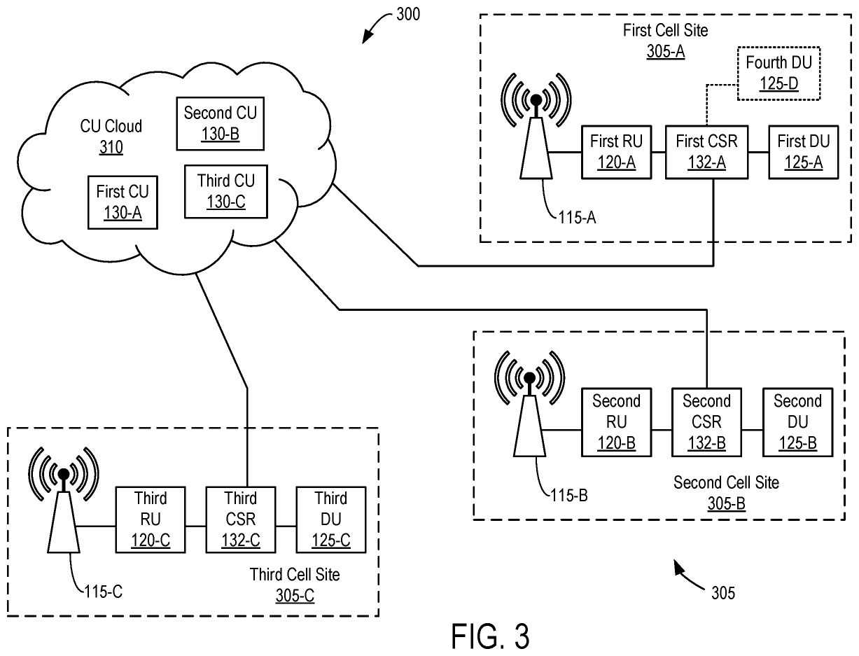

FIG. 3 illustrates an example of a CU cloud configuration 300 for a telecommunication network (e.g., the telecommunication network 100) in accordance with some aspects of the present disclosure. As illustrated in FIG. 3, the telecommunication network 100 may include multiple cell sites 305, including a first cell site 305-A, a second cell site 305-B, and a third cell site 305-C. While FIG. 3 illustrates the telecommunication network 100 as having three cell sites, the telecommunication network 100 may include additional, different, or fewer cell sites than illustrated in FIG. 3 in various configurations. Additionally, in some configurations, each cell site 305 may include additional, different, or fewer components than illustrated in FIG. 3 in different configurations.

As illustrated in FIG. 3, each cell site may include corresponding wireless access points 115, RUs 120, CSRs 132, and DUs 125. For instance, the first cell site 305-A includes a first wireless access point 115-A, a first RU 120-A, a first CSR 132-A, and a first DU 125-A; the second cell site 305-B includes a second wireless access point 115-B, a second RU 120-B, a second CSR 132-B, and a second DU 125-B; and the third cell site 305-C includes a third wireless access point 115-C, a third RU 120-C, a third CSR 132-C, and a third DU 125-C.

In some configurations, the telecommunication network 100 may include a CU cloud 310 that may host (or otherwise provide) a set of CUs (e.g., the CU(s) 130 of FIG. 1). In some configurations, the CU cloud 310 may represent a cloud-based computing platform or server, such as, e.g., a third-party cloud-based computing platform (e.g., as provided by Amazon Web Services). As illustrated in FIG. 3, the CU cloud 310 may include a first CU 130-A, a second CU 130-B, and a third CU 130-C. While FIG. 3 illustrates the CU cloud 310 as including three CUs 130, the CU cloud 310 may include additional, different, or fewer CUs 130 than illustrated in FIG. 3 in various configurations.

In some configurations, each CU 130 corresponds to (or is associated with) a specific cell site 300. For example, the first CU 130-A may be associated with the first cell site 305-A, the second CU 130-B may be associated with the second cell site 305-B, and the third CU 130-C may be associated with the third cell site 305-C. Alternatively, or in addition, in some configurations, a single CU 130 may be associated with multiple cell sites 305 (or the DU(s) 130 included therein). As one example, the first CU 130-A may be associated with the first cell site 305-A (e.g., the first DU 125-A), the second cell site 305-B (e.g., the second DU 125-B), and the third cell site 305-C (e.g., the third DU 125-C). As another example, the first CU 130-A may be associated with the second cell site 305-B (e.g., the second DU 125-B) and the third cell site 305-(e.g., the third DU 125-C). Accordingly, in some configurations, a single CU 130 may manage or control a single DU 125. Alternatively, in some configurations, a single CU 130 may manage or control multiple DUs 125.

As noted herein, in some instances, a cell site 305 may include multiple DUs 125. As one example, as illustrated in FIG. 3, the first cell site 305-A may include two DUs, the first DU 125-A and a fourth DU 125-D. In such instances, a single CU 130 may be associated with each DU 125 included in a cell site 305 (e.g., a single CU 130 may control the first DU 125-A and the fourth DU 125-D of the first cell site 305-A). Alternatively, a single CU 130 may be associated with a single DU 125 included in a cell site 305 (e.g., the first CU 130-A may control the first DU 125-A and the second CU 130-B may control the fourth DU 125-D of the first cell site 305-A).

According to the implementation illustrated in FIG. 3, the CUs 130 may be implemented as cloud-based cellular network components hosted or otherwise provided by a cloud-based computing platform or service. As such, in some configurations, the CUS 130 may be located on (e.g., sit on) the cloud (e.g., a cloud server or cloud-based computing platform). The components of the cell sites 305 (including, e.g., the DUs 130) may be located at a corresponding cell site (e.g., the first cell site 305-A, the second cell site 305-B, or the third cell site 305-C). For example, the first DU 130-A may be geographically or physically located within a proximity of the first wireless access point 115-A (e.g., on an on-site computing platform of the first wireless access point 115-A); the second DU 130-B may be geographically or physically located within a proximity of the second wireless access point 115-B (e.g., on an on-site computing platform of the second wireless access point 115-B); and the third DU 130-C may be geographically located within a proximity of the third wireless access point 115-C (e.g., on an on-site computing platform of the third wireless access point 115-C).

For purposes of explanation, the technology disclosed herein will be described as being implemented in a 5G O-RAN network; however, in practice technology disclosed herein may be implemented with any virtualized RAN architecture. Moreover, for purposes of explanation, the systems and methods described herein will be described as being implemented in a network operating using AWS; however, these are merely examples and not limiting. The systems and methods of the present disclosure may be implemented with other web services provider and with other container organization architectures. The methods described herein may be performed by a processing system including at least one electronic processor, where the at least one electronic processor may be or include a processor as previously described (e.g., including one or more individual electronic processors). A virtual RAN server is an example of such a processing system that may perform the methods described herein.

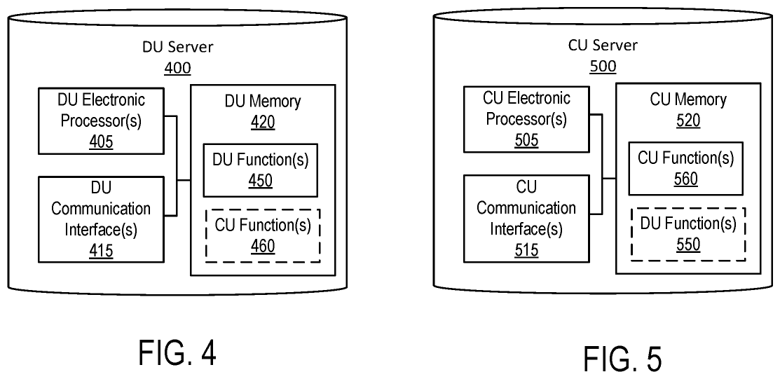

For example, one or more of the virtual RAN components (e.g., the DU(s) 125, the CU(s) 130, etc.) may be implemented using a virtual RAN server. For instance, a virtual RAN server may function as (e.g., provide the functionality associated with) one or more of the virtual RAN components (e.g., by controlling and executing corresponding software module(s) thereof). For instance, in some embodiments, the virtual RAN server may function as a DU 125 (as described in greater detail herein with respect to FIG. 4). In such embodiments, the virtual RAN server may store a set of instructions for executing one or more DU related network functions (e.g., RLC, MAC, PHY High, etc.). Additionally, in such embodiments, the virtual RAN server may be a local server located at corresponding cell site(s) 305 (e.g., as part of an on-site computing platform of a corresponding wireless access point 115 or cell site 305). Alternatively, or in addition, in some embodiments, the virtual RAN server may function as a CU 130 (as described in greater detail herein with respect to FIG. 5). In such embodiments, the virtual RAN server may store a set of instructions for executing one or more CU related network functions (e.g., PDCP, RRC, SDAP, etc.). Additionally, in such embodiments, the virtual RAN server may be a remote cloud server located remotely from corresponding cell site(s) 305.

As noted above, in some instances, the DU 125 may be implemented via a virtual RAN server configured to execute DU network functions. For example, FIG. 4 schematically illustrates an example DU server 400 according to some configurations. As illustrated in FIG. 4, the DU server 400 includes a DU electronic processor 405, a DU memory 410, and a DU communication interface 415. The DU electronic processor 405, the DU memory 410, and the DU communication interface 415 may communicate wirelessly, over one or more communication lines or buses, or a combination thereof. The DU server 405 may include additional, different, or fewer components than those illustrated in FIG. 4 in various configurations. The DU server 400 may perform additional or different functionality than the functionality described herein. Also, the functionality (or a portion thereof) described herein as being performed by the DU server 400 may be performed by another component (e.g., a CU server 500 as described in greater detail with respect to FIG. 5), distributed among multiple devices (e.g., as part of a cloud service or cloud-computing environment), combined with another component (e.g., another component of the telecommunications network 100), or a combination thereof.

The DU communication interface 415 may include a transceiver that communicates with other components of the telecommunications network 100, such as, e.g., the CSR(s) 132, the RU(s) 120, the CU(s) 130 (e.g., the CU server 500 as described in greater detail with respect to FIG. 5), etc. over one or more communication networks or connections. As one example, the DU communication interface 415 may receive network traffic from the RU 120 via the CSR 132 (e.g., mobile network traffic originating from one or more UEs 110). As another example, in some configurations, the DU communication interface 415 may transmit network traffic to the CU 130 via the CSR 132. The DU electronic processor 405 includes one or more processors (e.g., one or more microprocessors, one or more application-specific integrated circuits (“ASICs”), and/or one or more other suitable electronic device for processing data), and the DU memory 420 includes a non-transitory, computer-readable storage medium. The DU electronic processor 405 is configured to retrieve instructions and data from the DU memory 420 and execute the instructions.

For example, as illustrated in FIG. 4, the DU memory 420 may store one or more DU network functions 450. The DU network functions 450 may include, e.g., a RLC function or functionality, a MAC function or functionality, a PHY High function or functionality, etc. In some instances, upon receiving network traffic (via the DU communication interface 415, the DU electronic processor 400 may control the handling or processing of the network traffic using one or more of the DU functions 450, as described in greater detail herein. The DU electronic processor 400 may control the transmission of network traffic to other components within the telecommunication network 100, as described in greater detail herein.

As also illustrated in FIG. 4, the DU memory 420 may also include one or more CU functions 460. The CU functions 460 may include, e.g., a PDCP function or functionality, a RRC function or functionality, a SDAP function or functionality, etc. As described in greater detail herein, in some instances, the CU function 460 may be inactive or disabled (represented in FIG. 4 by the dashed outline of the CU function 460). However, in some instances, the CU function 460 may be activated or enabled, such as, e.g., responsive a network condition or event that triggers performance of a reconfiguration operation, as described in greater detail below. In some instances, the CU functions 460 may be stored in the DU memory 420 prior to an occurrence of a network condition (e.g., prior to being activated or enabled). Accordingly, in some instances, the CU functions 460 may be preemptively stored or preexisting in the DU memory 420.

As noted above, in some instances, the CU 130 may be implemented via a virtual RAN server configured to execute CU network functions. For example, FIG. 5 schematically illustrates an example CU server 500 according to some configurations. As illustrated in FIG. 5, the CU server 500 includes a CU electronic processor 505, a CU memory 510, and a CU communication interface 515. The CU electronic processor 505, the CU memory 510, and the CU communication interface 515 may communicate wirelessly, over one or more communication lines or buses, or a combination thereof. The CU server 500 may include additional, different, or fewer components than those illustrated in FIG. 5 in various configurations. The CU server 500 may perform additional or different functionality than the functionality described herein. Also, the functionality (or a portion thereof) described herein as being performed by the CU server 500 may be performed by another component (e.g., the DU server 400), distributed among multiple devices (e.g., as part of a cloud service or cloud-computing environment), combined with another component (e.g., another component of the telecommunications network 100), or a combination thereof.

The CU communication interface 515 may include a transceiver that communicates with other components of the telecommunications network 100, such as, e.g., the CSR(s) 132, the RU(s) 120, the DU(s) 125 (e.g., the DU server 400), etc. over one or more communication networks or connections. As one example, the CU communication interface 515 may receive network traffic from the DU 125 (e.g., the DU server 400) via the CSR 132. As another example, in some configurations, the CU communication interface 515 may transmit (or otherwise communicate) network traffic to the 5GC 135 (or components therein), including, e.g., an AMF (e.g., the AMF 226 of FIG. 2), a UPF (e.g., the UPF 208 of FIG. 2), or another component of the 5GC 135. The CU electronic processor 505 includes one or more processors (e.g., one or more microprocessors, one or more application-specific integrated circuits (“ASICs”), and/or one or more other suitable electronic device for processing data), and the CU memory 520 includes a non-transitory, computer-readable storage medium. The CU electronic processor 505 is configured to retrieve instructions and data from the CU memory 520 and execute the instructions.

For example, as illustrated in FIG. 5, the CU memory 520 may include one or more CU functions 560 (e.g., the CU functions 460 of FIG. 4). The CU functions 560 may include, e.g., a PDCP function or functionality, a RRC function or functionality, a SDAP function or functionality, etc. In some instances, the CU electronic processor 500 may control the handling or processing of network traffic using one or more of the CU functions 550, as described in greater detail herein. As one example, the CU electronic processor 500 may execute RRC to facilitate information broadcasting, establishing and releasing connections between the UE(s) 110 and the RAN, controlling quality of service, etc. (e.g., as part of the RRC network function or functionality). The CU electronic processor 500 may also implement PDCP for compressing and decompressing IP data stream headers, transferring user data, etc. (e.g., as part of the PDCP function or functionality). Alternatively, or in addition, in some configurations, the CU electronic processor 500 may implement a SDAP for mapping between a quality-of-service flow from the 5GC 135 and one or more DRBs (e.g., as part of the SDAP function or functionality).

In some instances, as illustrated in FIG. 5, the CU memory 520 may store one or more DU network functions 550 (e.g., the DU network functions 450 of FIG. 4). The DU network functions 550 may include, e.g., a RLC function or functionality, a MAC function or functionality, a PHY High function or functionality, etc. As described in greater detail herein, in some instances, the DU function 550 may be inactive or disabled (represented in FIG. 5 by the dashed outline of the DU function 550). However, in some instances, the DU function 550 may be activated or enabled, such as, e.g., responsive a network condition or event that triggers performance of a reconfiguration operation, as described in greater detail below. In some instances, the DU function 550 may be stored in the CU memory 520 prior to an occurrence of a network condition (e.g., prior to being activated or enabled). Accordingly, in some instances, the DU function 550 may be preemptively stored or preexisting in the CU memory 520.

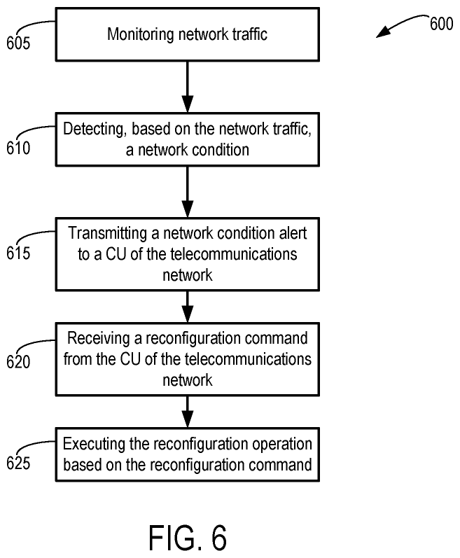

FIG. 6 illustrates a flowchart of an example method 600 for dynamically reconfiguring RAN components of telecommunication networks (e.g., the telecommunication network 100) according to some configurations. The method 600 is described as being performed by the DU server 400 and, in particular, the DU electronic processor 405. However, as noted above, the functionality (or a portion thereof) described with respect to the method 600 may be performed by other devices, such as, e.g., the CU server 500, or distributed among a plurality of devices, such as a plurality of servers included in a cloud service. Thus, although described as begin performed by the DU server 400, the method 600 may also be described as being performed by a processing system including one or more electronic processors (e.g., the DU electronic processor(s), the CU electronic processor(s) 505, and/or another processor or processors of the telecommunication network 100).

The method 600 includes monitoring network traffic at the DU 125 (e.g., the DU server 400) (at block 605). As noted herein, network traffic on the telecommunication network 100 may be received at the DU 125 from the RU 120 (via the CSR 132). In some configurations, to monitor network traffic at the DU 125, the DU electronic processor 405 may continuously monitor network traffic as the DU electronic processor 405 is also controlling the handling or processing of the network traffic. Alternatively, or in addition, in some configurations, the DU electronic processor 405 may periodically or intermittently monitor network traffic.

In some configurations, the DU electronic processor 405 may determine, based on the network traffic, key performance indicators (KPIs). KPIs may relate to availability, integrity, and mobility of the telecommunications network 100 (or component(s) thereof). A KPI generally refers to a quantifiable measurement of performance for a telecommunications network (or component(s) thereof). Example KPIs may include, e.g., peak data rate, peak spectral efficiency, data rate experienced by user, area traffic capacity, latency, connection density, average spectral efficiency, energy efficiency, reliability, mobility, mobility interruption time, bandwidth, mid haul transport congestion, backhaul transport congestion, number of radio bearers, active scheduled user over a measurement period and per transmit time interval, etc. As such, KPI(s) may provide insight(s) into network traffic demand and flow within the telecommunications network 100 (or components thereof).

Accordingly, in some configurations, the DU electronic processor 405 may determine one or more KPIs for the DU 125 (e.g., the DU server 400) based on network traffic at the DU 125 (e.g., the DU server 400). For example, in some examples, the DU electronic processor 405 may determine the KPI(s) based on processing of output from sensors, execution of KPI software configured to analyze network traffic and output KPIs (e.g., in response to requests for KPI data)), reading KPI data from a memory of the telecommunications network 100, receive KPI data from RAN components of the telecommunications network 100, transport components of the cellular network, etc.

The DU electronic processor 405 may detect a network condition (or an occurrence thereof) (at block 610). In some configurations, the network condition occurs at the DU server 400. Alternatively, or in addition, in some configurations, the network condition may occur at another component, such as, e.g., the CU 130 (e.g., the CU server 500), as described in greater detail herein. A network condition may include, for example, a congestion condition (also referred to as an over-utilization condition), an under-utilization condition, and/or a fault condition. In some instances, the network condition may be component specific. For example, an amount of utilization that is a considered a congestion condition for a first RAN component may be different than for a second RAN component, where the first and second RAN components may have different amounts of resources available for handling network traffic.

In some examples, a network condition may include a congestion condition at a RAN component of the telecommunication network 100 (e.g., an over-utilization condition of the RAN component). As one example, a congestion condition may occur when a network demand on a particular RAN component exceeds a maximum-demand threshold (e.g., indicating an over-utilization of that particular RAN component). As another example, a congestion condition may occur when a data rate at a RAN component falls below a data rate threshold, which may indicate that the RAN component is experiencing congestion.

Alternatively, or in addition, in some examples, a network condition may include an under-utilization condition (e.g., a lack of network traffic demand). For instance, an under-utilization condition may occur when a RAN component is not being utilized or is underutilized. Such a network condition may occur during certain time periods (e.g., overnight, weekends, etc.), where said time periods are associated with a diminished network traffic demand. As one example, an under-utilization condition (as a network condition) may occur when demand on a particular RAN component is below a minimum-demand threshold (e.g., indicating an under-utilization of that particular RAN component).

Alternatively, or in addition, in some examples, a network condition may include a fault condition (e.g., a failure or error experienced in the telecommunications network 100). A fault condition may occur when one or more components of the telecommunications network 100 are down or are not performing as expected.

In some configurations, the DU electronic processor 405 may detect the network condition based on the monitored network traffic, the KPI(s), or a combination thereof. As one example, the DU electronic processor 405 may detect a network condition when the monitored network traffic, the KPI(s), or a combination thereof indicate that a RAN component is being overutilized (e.g., the over-utilization condition). As another example, the DU electronic processor 405 may detect the network condition when the monitored network traffic, the KPI(s), or a combination thereof indicate that a RAN component is being underutilized (the under-utilization condition). As yet another example, the DU electronic processor 405 may detect a network condition when the monitored network traffic, the KPI(s), or a combination thereof indicate that a RAN component is experiencing a fault or failure.

In some examples, the DU electronic processor 405 may detect the network condition based on the monitored network traffic, the KPI(s), or a combination thereof, by, for example, (i) comparing one or more quantifications of the network traffic as determined in block 605 (e.g., expressed in terms of data per time period (e.g., bits per second) being communicated, number of active communication links with UEs or other devices, or the like) to a corresponding threshold for each of one or more of the corresponding RAN components associated with or handling the network traffic; (ii) comparing one or more KPIs to corresponding one or more thresholds for each of one or more of the corresponding RAN components associated with the KPI(s); or (iii) both (i) and (ii). For example, the DU electronic processor 405 may detect the congestion condition for the DU 125 (as the network condition) in response to determining that the network traffic at the DU 125 exceeds a traffic threshold indicative of congestion. In another example, the DU electronic processor 405 may detect the congestion condition for the DU 125 (as the network condition) in response to determining that a first KPI for the DU 125 exceeds a first KPI threshold indicative of congestion. The first KPI may be a particular KPI or may be any KPI selected from a group of KPIs for the DU 125. In another example, the DU electronic processor 405 may detect the congestion condition for the DU 125 (as the network condition) in response to determining that both a first KPI for the DU 125 exceeds a first KPI threshold indicative of congestion and a second KPI for the DU 125 exceeds a second KPI threshold indicative of congestion. These examples are merely for illustration and various combinations of network traffic and/or KPIs may be compared to corresponding thresholds (referred to as condition thresholds) to determine whether a network condition exists. Thus, the DU electronic processor 405 may detect the network condition based on network traffic in response to a comparison of network traffic information (e.g., monitored network traffic, the KPI(s), or a combination thereof) to one or more condition thresholds.

In some configurations, the DU electronic processor 405 may transmit a network condition alert (e.g., as one or more electronic signals forming an electronic message) to the CU 130 (e.g., the CU server 500) indicating the occurrence of the network condition (at block 615). The network condition alert may include, e.g., the network condition (e.g., an over-utilization condition, an under-utilization condition, a fault condition, etc.), the RAN component experiencing the network condition (e.g., the particular DU 125, the particular CU 130, etc.), one or more characteristics of the RAN component experiencing the network condition (e.g., RAN component type, available resources at the RAN component, etc.), network traffic characteristics associated with the network condition (e.g., the monitored network traffic, the KPI(s), etc. that triggered the network condition), etc.

Responsive to receiving the network condition alert, the CU 125 (e.g., the CU electronic processor 505 of the CU server 500) may determine a reconfiguration operation for responding to the network condition. The reconfiguration operation may be configured to mitigate or eliminate the network condition. For example, when the network condition is an over-utilization condition, the reconfiguration operation may attempt to mitigate or eliminate the overutilization by, e.g., re-routing at least a portion of network traffic from the overutilized RAN component to a different RAN component having available resources. As another example, when the network condition is a failure condition, the reconfiguration operation may attempt to mitigate or eliminate the failure condition. For instance, when a CU is down, the role or functionality of the CU that is down may be shifted to another network component, such as, e.g., a DU. Shifting functionality of a down component to an available component provides for efficient outage handling, such that the network may continue to run even though a component may be down.

The reconfiguration operation may include a set of instructions for dynamically reconfiguring the telecommunications network 100, including, e.g., the DU 125, the CU 130, etc. For example, the reconfiguration operation may include a set of instructions for execution by the DU 125 for re-routing a portion of network traffic to another DU such that when the set of instructions are executed by the DU 125, the portion of network traffic is re-routed to another DU of the telecommunications network 100. As another example, the reconfiguration operation may include a set of instructions for execution by the DU 125 for activating one or more CU functions (e.g., the CU function(s) 460 of FIG. 4) and, ultimately, then executing the activated one or more CU functions. As yet another example, the reconfiguration operation may include a set of instructions for execution by the CU 130 for activating one or more DU functions (e.g., the DU function(s) 550 of FIG. 5) and, ultimately, then executing the activated one or more DU functions.

Accordingly, in some configurations, the reconfiguration operation may include the reconfiguration of a component of the telecommunications network 100. Alternatively, or in addition, in some configurations, the reconfiguration operation may include reconfiguring multiple components of the telecommunications network 100. For example, in some configurations, the reconfiguration operation may reconfigure the DU 125 and the CU 130. As another example, in some configurations, the reconfiguration operation may reconfigure a first DU and a second DU. For instance, in some instances, the reconfiguration operation may include a first DU functioning as a CU (e.g., via activation and execution of CU function(s) at the first DU) for a second DU of the telecommunications system 100.

In some configurations, the reconfiguration operation may be determined based on characteristics of the telecommunications network 100 (or component(s) thereof). For example, with respect to CU variations (or reconfigurations), the reconfiguration operation may be determined based on a number of DUs served by a CU instance, a mid haul aggregated transport bandwidth, a simultaneous number of CU users, a maximum allowed CU users, an average number of simultaneous radio bearers, a maximum number of simultaneous radio bearers, a number of RRC users supported, a transport bandwidth requirement towards UPF, a transport connectivity towards multiple UPFs, a number of cells supported, a type of delay tolerant services supported, a connectivity towards one or several AMFs, a number of DU variants supported, a number of DUs transformed to perform CU functionality, a number of scaled up DUs supported, a number of scaled down DUs supported, a slice and service type supported, etc. As another example, with respect to DU variations (or reconfigurations), the reconfiguration operation may be determined based on a number of users, a number of radio bearers, a number of simultaneous PRB resources, a number of cells supported, a number of sectors supported, DU bandwidth, DU sector bandwidth, a number of connected RUs, NB-IoT support, fixed wireless access service support, slice support, a number of enabled RAN feature support, a number of RU variant support, a number of delay sensitive and delay tolerant service support, mid haul transport capacity, etc.

Once the CU 130 determines the reconfiguration operation for responding to the network condition, the CU 130 (e.g., the CU electronic processor 505) may transmit a reconfiguration command (e.g., as one or more electronic signals forming an electronic message) back to the DU 125. Accordingly, in some configurations, the DU 125 (e.g., the DU electronic processor 405) may receive a reconfiguration command (e.g., from the CU 130) (at block 620). The reconfiguration command may represent the reconfiguration operation (or instructions for execution of the reconfiguration operation). For instance, as noted above, the reconfiguration operation may be a set of instructions for executing the reconfiguration operation. As such, in some configurations, the reconfiguration command may include the set of instructions for executing the reconfiguration operation. Responsive to receiving the reconfiguration command (e.g., at block 620), the DU electronic processor 405 may execute the reconfiguration operation based on the reconfiguration command (at block 625). Alternatively, or in addition, in some configurations, the CU electronic processor 505 may execute the reconfiguration operation based on the reconfiguration command.

In some configurations, the DU electronic processor 405 may execute the reconfiguration operation by providing a notification indicating an amount of data resources available at one or more RAN components. In some examples, the DU electronic processor 405 may generate and transmit a notification for the UE 110, where the notification may indicate an amount of data resources available at the DU 125 for the UE 110. For instance, in some instances, the reconfiguration operation may include providing data allocation or availability information to one or more components of the telecommunications network 100 (as a data allocation or availability notification). Alternatively, or in addition, in some configurations, the DU electronic processor 405 may provide other data related information to one or more components of the telecommunications network 100, such as, e.g., a present data rate, etc.

As noted herein, one example of a reconfiguration operation may include re-routing network traffic (or a portion thereof) from a first RAN component to one or more other RAN components. Accordingly, in some configurations, the DU electronic processor 405 may control re-routing of network traffic (or a portion thereof) at the DU 125 to another component of the telecommunications network 100. As one example, the DU electronic processor 405 may re-route network traffic to another DU 125 (e.g., a DU 125 having available resources for handling the re-routed network traffic). As another example, the DU electronic processor 405 may re-route network traffic to the CU 130. In such an instance, the CU electronic processor 505 may activate the DU function(s) 550. As yet another example, the DU electronic processor 405 may re-route a first portion of network traffic to a first RAN component of the telecommunications network 100 and a second portion of network traffic to a second RAN component of the telecommunications network 100.

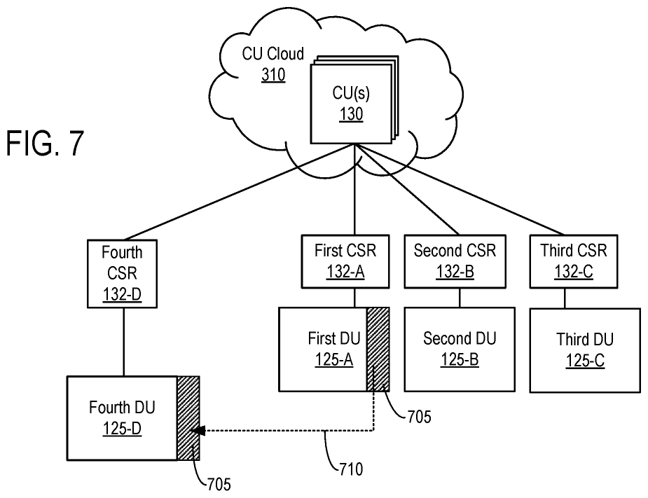

As one example, FIG. 7 illustrates an example reconfiguration operation for re-routing network traffic between DUs to mitigate congestion according to some configurations. The process of FIG. 6 may be executed to perform the example configuration of FIG. 7. In the example of FIG. 7, the first DU-A 125-A may be over-utilized and the fourth DU 125-D may be under-utilized. The first DU 125-A may detect that a network condition (e.g., over-utilization) has occurred and communicate the occurrence of the network condition with one or more of the CUs 130 included in the CU cloud 310. In response, the CU(s) 130 may determine a reconfiguration operation to mitigate the over-utilization occurring at the first DU 125-A. Such a determination may include identifying a RAN component with the available resources to help alleviate the over-utilization of the first DU 125-A. The CU(s) 130 may transmit a reconfiguration command to the first DU 125-A. The reconfiguration command may instruct the first DU 125-A to re-route at least a portion of the network traffic (represented in FIG. 7 by reference numeral 705) to the fourth DU 125-D. The re-routing of the network traffic 705 is represented in FIG. 7 by the dashed arrow 710. The traffic routing may be through a CSR for DU to DU communication and DUs served by a CU can share their load information or resource availability for pooling, including the transport bandwidth congestion between them periodically with IP route information to use for sharing.

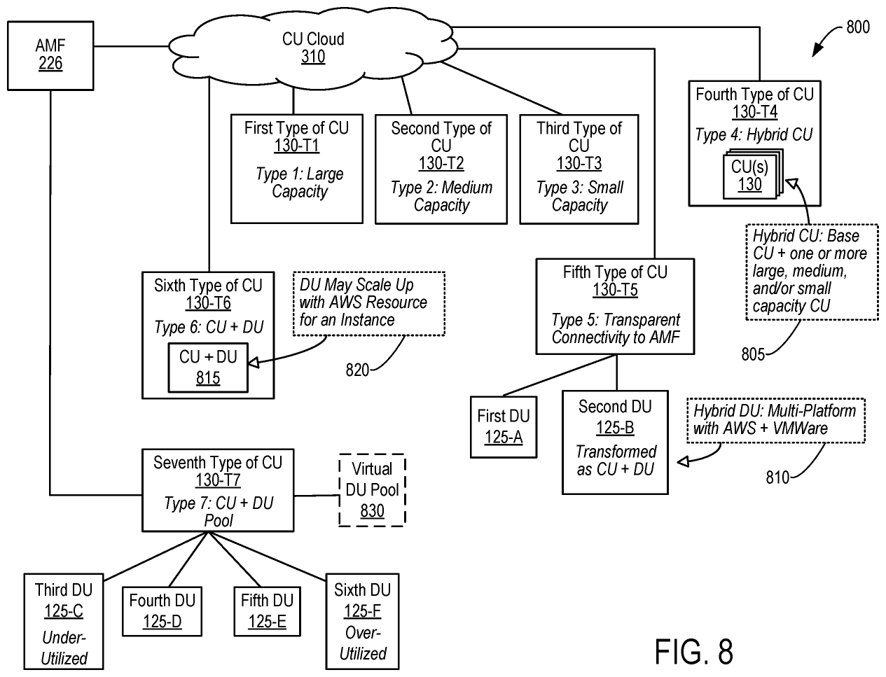

FIG. 8 illustrates an example telecommunications network 800 (e.g., the telecommunications network 100) that has been dynamically reconfigured in according with some configurations. The process of FIG. 6 may be executed to perform the example configuration of FIG. 8. In the example of FIG. 8, the telecommunications network 800 may include various types (or variants) of RAN components. For example, the telecommunications network 800 may include a first type of CU 130-T1 having a large capacity, a second type of CU 130-T2 having a medium capacity, and a third type of CU 130-T3 having a small capacity. Accordingly, in some configurations, the CUs 130 included in a telecommunications network (e.g., the telecommunications network 800 or the telecommunications network 100) may have various or different capacity or sizes. In the example of FIG. 8, the telecommunications network 800 may include a fourth type of CU 130-T4. The fourth type of CU 130-T4 may be a hybrid CU including a base CU and one or more additional CUs, where the additional CUs may be of various sizes (represented in FIG. 8 by reference numeral 805). In some configurations, the fourth type of CU 130-T4 may be the result of a reconfiguration operation that added the additional CUs to the base CU (e.g., as part of the process of FIG. 6).

In the example of FIG. 8, the telecommunications network 800 may include a fifth type of CU 130-T5. The fifth type of CU 130-T5 may provide transparent connectivity to an AMF function (e.g., the AMF 226) of the telecommunications network 800. As illustrated in FIG. 8, in some instances, the fifth type of CU 130-T5 may be coupled to a first DU 125-A and a second DU 125-B. In some instances, as illustrated in FIG. 8, the second DU 125-B may have been reconfigured such that the second DU 125-B may perform CU functionality and DU functionality (e.g., via the process of FIG. 6). The second DU 125-B may be a hybrid DU for implementing a multi-platform with AWS and VMWare (represented in FIG. 8 by reference numeral 810).

The telecommunications network 800 may include a sixth type of CU 130-T6. The sixth type of CU 130-T6 may perform CU functionality and DU functionality (represented in FIG. 8 by reference numeral 815). For instance, as described in greater detail herein, when a DU is over-utilized, a CU may perform DU functionality for the over-utilized DU. For example, in some configurations, a DU may scale up with AWS resource or another resource or central resource donor capable of sharing necessary compute, CPU, memory, etc. for carrying out the NF(s) for an instance (represented in FIG. 8 by reference numeral 820). The sixth type of CU 130-T6 may be a dynamic reconfiguration performed as part of the process of FIG. 6.

The telecommunications network 800 may include a seventh type of CU 130-T7. The seventh type of CU 130-T7 may perform CU functionality and be coupled to (or otherwise communicate with or access) a virtual DU pool 830. The virtual DU pool 803 may include one or more virtual DUs. For instance, in some implements, the hardware or servers with necessary interfaces to share CPU, memory, etc. available in a central location which can be used or reconfigured as CU or DU on need-basis. Accordingly, the virtual DU pool 803 may represent the CPU, memory, interfaces, compute, etc. available to spin multiple DUs on need-basis. As illustrated in FIG. 8, the seventh type of CU 130-T7 may communicate with a third DU 125-C, a fourth DU 125-D, a fifth DU 125-E, and a sixth DU 125-F. In the example of FIG. 8, the third DU 125-C is under-utilized (e.g., has available or unused resources) and the sixth DU 125-F is over-utilized. In some configurations, using the process of FIG. 6, the third DU 125-C may lend resources to the sixth DU 125-F such that the over-utilization of the sixth DU 125-F is mitigated or eliminated (e.g., via re-routing network traffic from the sixth DU 125-F to the third DU 125-C).

Other examples and uses of the disclosed technology will be apparent to those having ordinary skill in the art upon consideration of the specification and practice of the technology disclosed herein. The specification and examples given should be considered exemplary only, and it is contemplated that the appended claims will cover any other such embodiments or modifications as fall within the true scope of the technology disclosed herein.

The Abstract accompanying this specification is provided to enable the United States Patent and Trademark Office and the public generally to determine quickly from a cursory inspection the nature and gist of the technical disclosure and in no way intended for defining, determining, or limiting the present technology disclosed herein or any of its embodiments.

What is claimed is:

1. A method of dynamically reconfiguring radio access network (RAN) components of a telecommunications network, the method comprising:
monitoring, with a processing system including one or more electronic processors, network traffic at a first distributed unit (DU) included in the telecommunications network;
detecting, with the processing system, based on the network traffic, an occurrence of a network condition at the first DU;
transmitting, with the processing system, a first one or more electronic signals forming a first electronic message to a centralized unit (CU) of the telecommunications network indicating the occurrence of the network condition;
receiving, with the processing system, a second one or more electronic signals forming a second electronic message from the CU, wherein the second electronic message is responsive to the network condition; and
controlling, with the processing system, the first DU to perform a reconfiguration operation based on the second electronic message.

2. The method of claim 1, wherein controlling the first DU to perform the reconfiguration operation includes dynamically reconfiguring the telecommunications network by modifying which network component handles at least a portion of the network traffic.

3. The method of claim 1, wherein controlling the first DU to perform the reconfiguration operation includes:
generating a first notification for a first user equipment (UE) of the telecommunications network, wherein the first notification indicates an amount of data resources available at the first DU for the first UE; and
transmitting, via the telecommunications network, the first notification to the first UE via a corresponding radio unit (RU).

4. The method of claim 1, wherein controlling the first DU to perform the reconfiguration operation includes:
generating a second notification for a first UE of the telecommunications network, wherein the second notification includes a set of instructions for re-routing network traffic of the first UE to a second DU of the telecommunications network; and
transmitting, via the telecommunications network, the second notification to the first UE via a corresponding RU.

5. The method of claim 4, further comprising:
identifying the second DU based on a first amount of resources available at the second DU and a second amount of resources associated with the network traffic of the first UE, wherein the second amount of resources is smaller than the first amount or resources.

6. The method of claim 1, wherein controlling the first DU to perform the reconfiguration operation includes:
accessing a CU function locally stored at the first DU; and
executing the CU function at the first DU.

7. The method of claim 6, wherein executing the CU function includes executing a radio resource control (RRC) function at the first DU.

8. A system of dynamically reconfiguring radio access network (RAN) components of a telecommunications network, the system comprising:
a processing system comprising one or more electronic processors, the processing system configured to:
monitor network traffic within the telecommunications network including a plurality of RAN components;
detect, based on the network traffic, a network condition at a first RAN component of the plurality of RAN components;
determine a reconfiguration operation based on the network condition; and
dynamically reconfigure at least one of the plurality of RAN components of the telecommunications network by performing the reconfiguration operation.

9. The system of claim 8, wherein the first RAN component is a centralized unit (CU) of the telecommunications network.

10. The system of claim 9, wherein the network condition includes network traffic congestion at the CU and the reconfiguration operation mitigates the network traffic congestion at the CU.

11. The system of claim 8, wherein the processing system is configured to dynamically reconfigure the telecommunications network by triggering a distributed unit (DU) included in the plurality of RAN components of the telecommunications network to execute a CU function locally at the DU.

12. The system of claim 11, wherein the CU function includes a radio resource control (RRC) function.

13. The system of claim 8, wherein the processing system is configured to detect the network condition based on a plurality of key performance indicators for the plurality of RAN components.

14. The system of claim 8, wherein the first RAN component is a first distributed unit (DU) of the telecommunications network.

15. The system of claim 14, wherein the network condition includes network traffic congestion at the first DU and the reconfiguration operation mitigates the network traffic congestion at the first DU.

16. The system of claim 14, wherein the processing system is configured to dynamically reconfigured the telecommunications network by re-routing at least a portion of the network traffic at the first DU to a second DU included in the plurality of RAN components of the telecommunications network, the second DU being different from the first DU.

17. The system of claim 14, wherein the processing system is configured to dynamically reconfigured the telecommunications network by re-routing at least a portion of the network traffic at the first DU to a centralized unit (CU) included in the plurality of RAN components of the telecommunications network.

18. A non-transitory computer-readable medium storing instructions that, when executed by one or more electronic processors of a processing system in a telecommunications network, cause the processing system to perform operations comprising:
receiving, at a first distributed unit (DU) of the telecommunications network, network traffic from a user equipment (UE) coupled to the telecommunications network;
controlling handling of the network traffic with the first DU, executing a set of DU network functions, and a centralized unit (CU), executing a set of CU network functions, of the telecommunications network;
receiving, at the first DU, subsequent network traffic;
detecting a network condition at the first DU, wherein the network condition is a result of receiving the subsequent network traffic at the first DU;
responsive to detecting the network condition, dynamically reconfiguring the first DU of the telecommunications network; and
controlling handling of the subsequent network traffic using the dynamically reconfigured first DU of the telecommunications network.

19. The computer-readable medium of claim 18,
wherein dynamically reconfiguring the first DU of the telecommunications network includes enabling, at the first DU, a CU network function of the set of CU network functions, and
wherein controlling handling of the subsequent network traffic includes executing, at the first DU, the CU network function.

20. The computer-readable medium of claim 18, wherein dynamically reconfiguring the first DU of the telecommunications network includes re-routing at least a portion of the subsequent network traffic to a second DU of the telecommunications network, wherein the second DU has resources available to handle the at least a portion of the subsequent network traffic.
